(19) United States
(12) Patent Application Publication
(10) Pub. No.: US 2023/0343477 A1
(43) Pub. Date: Oct. 26, 2023

(54) UNIVERSAL REACTOR VESSEL HEAD INSPECTION PLATFORM ASSEMBLY

(71) Applicant: Westinghouse Electric Company LLC, Cranberry Township, PA (US)

(72) Inventor: David W. EARGLE, Greensburg, PA (US)

(73) Assignee: Westinghouse Electric Company LLC, Cranberry Township, PA (US)

(21) Appl. No.: 17/759,415

(22) PCT Filed: Jan. 19, 2021
(86) PCT No.: PCT/US2021/013957

§ 371 Date: Jul. 25, 2022

Related U.S. Application Data
(60) Provisional application No. 62/965,657, filed on Jan. 24, 2020.

(51) Int. Cl. G21C 17/013; G21C 19/20; B25J 5/00; B25J 19/02; B25J 11/00; B25J 9/16

(52) U.S. Cl. CPC G21C 17/013; B25J 5/007; B25J 9/162; B25J 9/1664; B25J 11/00; B25J 19/022; B25J 19/023; G21C 19/207

(57) ABSTRACT

A mobile robotic assembly for guiding an end effector in inspecting reactor vessel heads is disclosed. The mobile robotic assembly includes a mobile platform; a support assembly extending vertically from the mobile platform, wherein the support assembly comprises an adjustable height; and a robotic arm attached to and extending laterally from the support assembly.

### CROSS-REFERENCE TO RELATED APPLICATION

This application claims priority under 35 U.S.C. §119 to U.S. Provisional Pat. Application No. 62/965,657, filed, Jan. 24, 2020, and titled UNIVERSAL REACTOR VESSEL HEAD INSPECTION PLATFORM ASSEMBLY, which is hereby incorporated by reference herein in its entirety.

### BACKGROUND

Nuclear reactor vessels employed in the commercial generation of electrical power are generally of two types: the pressurized water type and the boiling water type. Safety regulations require periodic inspections of the nuclear reactor vessels whereby the structural integrity of the vessels are monitored. Since the vessels are not uniform in size or design, existing inspection devices are special-purpose devices designed for use with limited vessel sizes and/or designs. A need exists for a universal inspection device capable of accommodating a variety of reactor vessel sizes and designs. Aspects of the present disclosure provide a universal delivery system, which can be utilized with a variety of inspection devices to perform a vessel inspection regardless of plant design or size, thus removing the need to maintain multiple inspection delivery systems and reducing maintenance costs.

### SUMMARY

In one aspect, the present disclosure provides a mobile robotic assembly for guiding an end effector in inspecting reactor vessel heads. The mobile robotic assembly comprises a mobile platform; a support assembly extending vertically from the mobile platform, wherein the support assembly comprises an adjustable height; and a robotic arm attached to and extending laterally from the support assembly. The robotic arm comprises articulation joints; motor assemblies for driving selective articulations at each of the articulation joints; discrete segments extending between the articulation joints; a connector for releasably connecting the end effector to the robotic arm; and a rotation motor assembly for rotating the robotic arm about a longitudinal axis defined therethrough.

In another aspect, the present disclosure provides a method of inspecting a reactor vessel head positioned on a headstand using a mobile robotic assembly with a robotic arm positioned on an adjustable support assembly. The method comprises: passing a mobile robotic assembly through an access port of the headstand; remotely guiding the mobile robotic assembly to a first location underneath the reactor vessel head; remotely adjusting a height of the support assembly to a first height corresponding to a first inspection sight in the reactor vessel head; remotely moving the robotic arm to bring an end effector within a sufficient proximity from the first inspection sight; remotely guiding the mobile robotic assembly to a second location underneath the reactor vessel head; remotely adjusting the height of the support assembly to a second height corresponding to a second inspection sight in the reactor vessel head, wherein the second height is different than the first height; and remotely moving the robotic arm to bring the end effector within a sufficient proximity from the second inspection sight.

In another aspect, the present disclosure provides a mobile robotic assembly for guiding an end effector in inspecting a reactor vessel head. The mobile robotic assembly comprises: a mobile platform; a support assembly extending vertically from the mobile platform, wherein the support assembly comprises an adjustable height; a robotic arm attached to and extending laterally from the support assembly. The control circuit is configured to: receive a signal indicative of a specified location within a reactor vessel head; determine a current location of the mobile robotic assembly; develop a route for reaching the specified location, and cause the mobile robotic assembly to move to the specified location along the route.

### DRAWINGS

Various features of the embodiments described herein are set forth with particularity in the appended claims. The various embodiments, however, both as to organization and methods of operation, together with advantages thereof, may be understood in accordance with the following description taken in conjunction with the accompanying drawings as follows:

FIG. 1 is a perspective view of a universal reactor vessel head inspection (hereinafter “RVHI”) platform assembly, in accordance with at least one aspect of the present disclosure.

FIGS. 1A-1D illustrate the RVHI platform assembly of FIG. 1 performing reactor vessel head inspections.

FIG. 2 is a top view of the RVHI platform assembly of FIG. 1.

FIG. 3 is a side elevational view of the RVHI platform assembly of FIG. 1.

FIG. 4 is a back view of the RVHI platform assembly of FIG. 1.

FIG. 5 is a front view of the RVHI platform assembly of FIG. 1.

FIG. 6 is a bottom view of the RVHI platform assembly of FIG. 1.

FIG. 7 illustrates a partial top view of the RVHI platform assembly of FIG. 1.

FIG. 8 illustrates a partial elevational view of the RVHI platform assembly of FIG. 1.

FIG. 9 illustrates a simplified schematic of a control system of the RVHI platform assembly of FIG. 1.

Corresponding reference characters indicate corresponding parts throughout the several views. The exemplifications set out herein illustrate various embodiments, in one form, and such exemplifications are not to be construed as limiting.

### DESCRIPTION

Before explaining various aspects of a surgical visualization platform in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

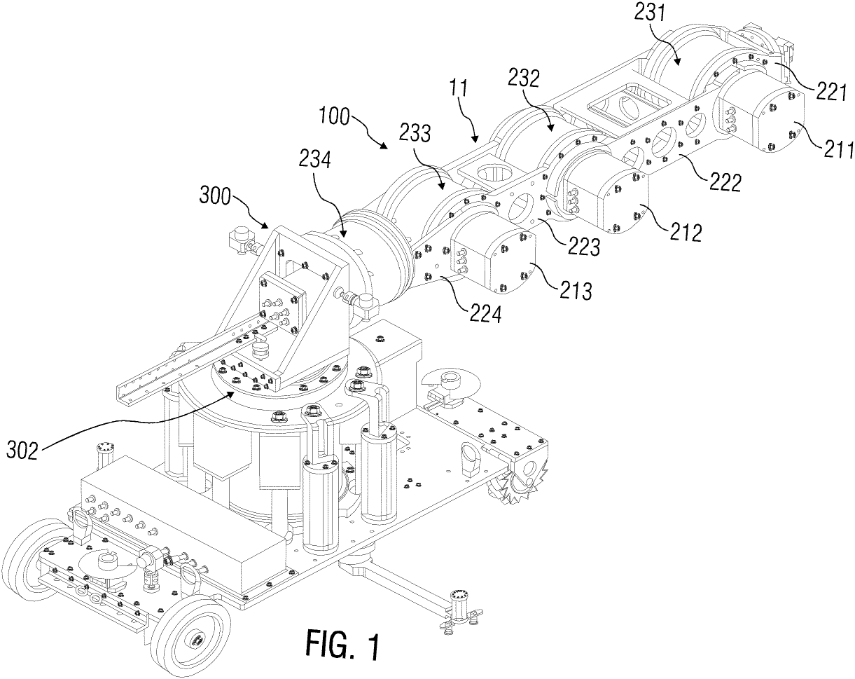

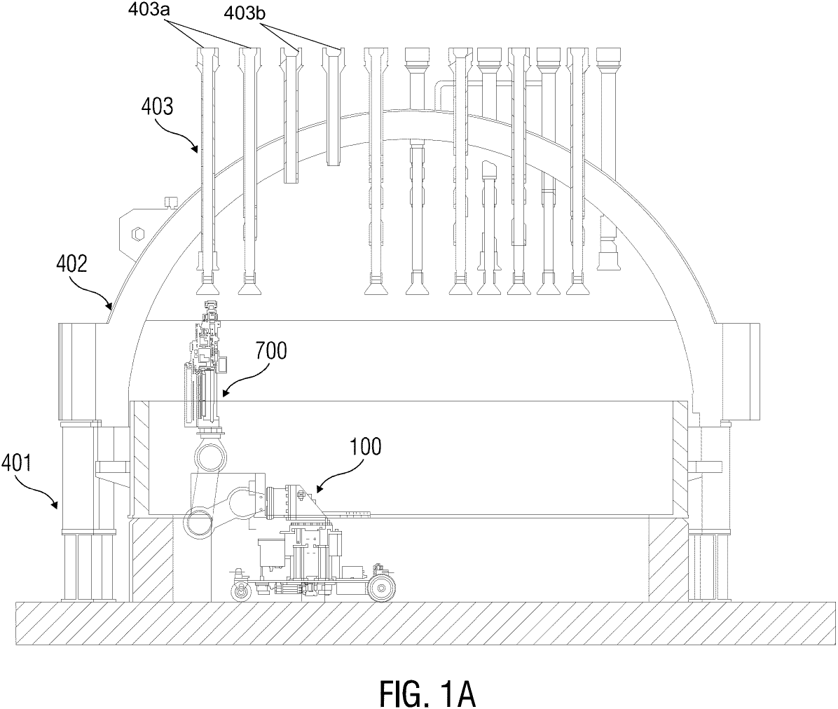

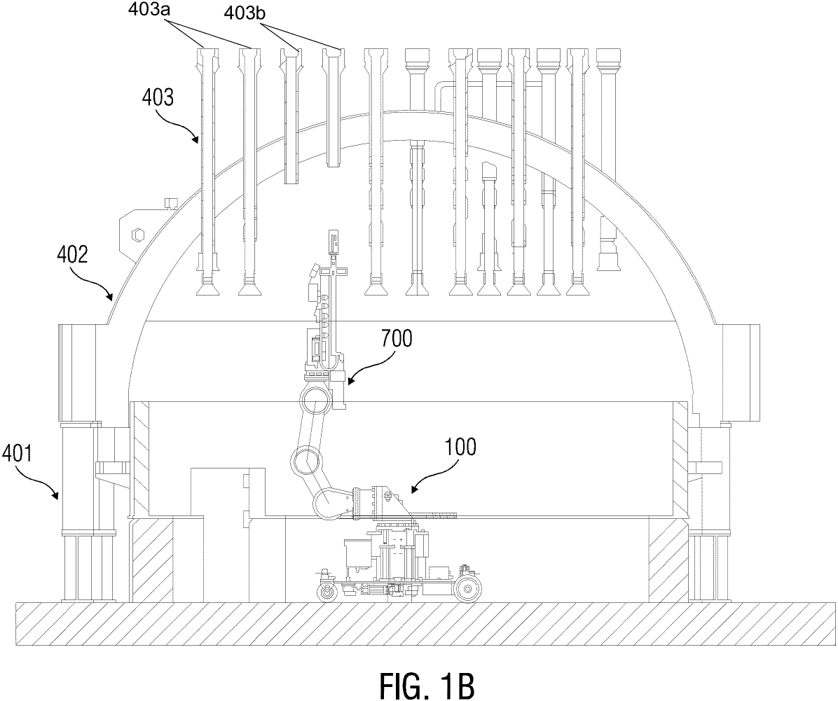

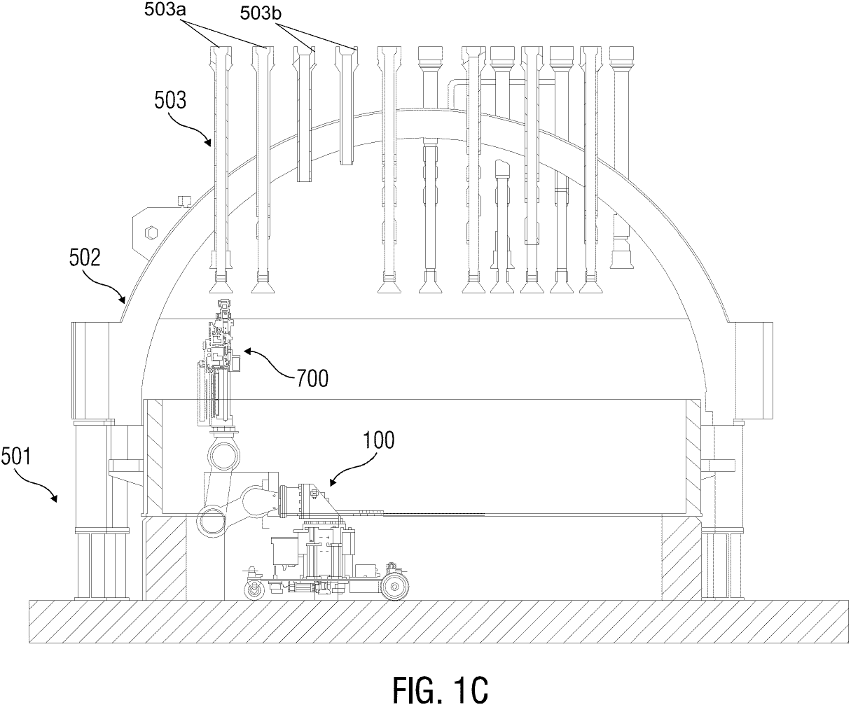

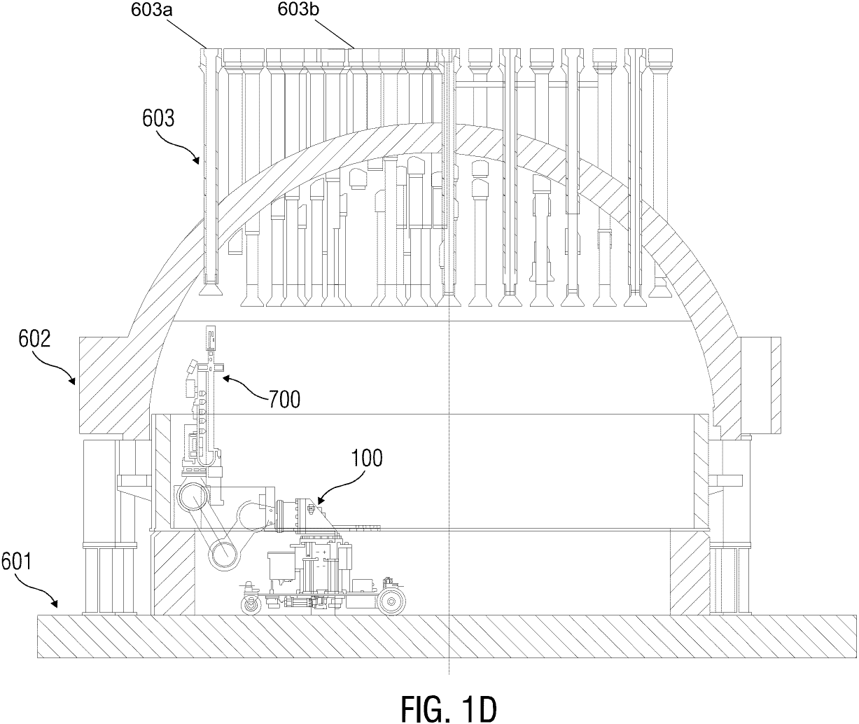

Referring generally to FIGS. 1A-1D, to inspect a reactor vessel head (e.g. 402, 502, 602), a polar crane is utilized to lift and position the reactor vessel head on a headstand (e.g. 401, 501, 601). A reactor vessel head is typically about 154,000 pounds making its manipulation a difficult task. As such, existing inspection equipment are typically placed within the headstand, for example using the polar crane, prior to the positioning of the reactor vessel head onto the headstand. This approach causes the inspection equipment to be trapped under the reactor vessel head until after all refueling services are completed and the reactor vessel head has been reinstalled on the vessel. Another approach relies on dedicated inspection equipment that are specifically dimensioned for use with a particular reactor vessel head and a particular headstand. Needless to say, both approaches are not cost effective.

Reactor vessel head inspection typically involves a close inspection of its penetrations (e.g. 403, 503, 603) and surrounding welds, which requires positioning an end effector in close proximity to the penetrations/welds. In a single reactor vessel head, as illustrated in FIGS. 1A and 1B, there can be occupied penetrations (403a, 503a, 603a) and unoccupied penetrations (403b, 503b, 603b), which require different inspection heights. Furthermore, since reactor vessel heads comprise different sizes, their headstands also comprise different sizes. FIGS. 1C and 1D illustrate two reactor vessel heads 502, 602 positioned on headstands 501, 601 comprising different heights, which also yields different inspections heights.

FIG. 1 illustrates a mobile universal RVHI platform assembly 100 adaptable for use with different inspection heights, different reactor vessel heads, and different headstands. Each assembly 100 includes at least one remotely operated service arm 11 (hereinafter “ROSA”) mounted to a height-adjustable support assembly 3. ROSA 11 includes a number of discrete segments adjustable to deliver various end effectors to reactor vessel head penetration locations for inspection, as illustrated in FIGS. 1A-1D. The assembly 100 is designed and/or dimensioned to fit through a standard reactor vessel headstand access portal, with the capability of remotely docking its articulating arm to a base for plants with access portals too small to accommodate passing of the assembly 100 therethrough.

In various aspects, the support assembly 3 is centrally located on a mobile platform 10, and is vertically expandable such as, for example, by telescoping vertically. Accordingly, the height of the support assembly 3 can be changed to accommodate smaller or larger headstand access portals, or higher or lower headstands, as illustrated in FIGS. 1A-1D. As the headstand elevation is changed, the reach requirements of the ROSA 11 can be increased or reduced by adjusting the height of the support assembly 3. The selectively changeable height allows the assembly 100 to be used to perform inspections at different sites where reach requirements can vary for each type of inspection performed, and where penetrations are on different elevations.

Existing inspection devices require specific headstand access dimensions, and may require sites to have temporary or permanent headstand extensions installed. The capability of installation of the assembly 100 through the access portal in the headstand permits a quick access in the event of an emergent head inspection scenario. Currently, an emergent inspection requires draining down the cavity, placing the head on the vessel, installing the inspection equipment, placing the reactor vessel head back on the stand, and flooding up the cavity again. These steps present a complication in the event of an emergent inspection, which is avoided by using the assembly 100.

Moreover, during standard inspections, existing inspection equipment cannot be removed directly after completion of their inspection tasks, as the existing inspection equipment cannot be pulled from under a reactor vessel head until after all refueling services are completed and the reactor vessel head has been reinstalled on the vessel. Accordingly, existing inspection equipment typically remains idle until the end of the site outage. Such delay can be associated with unavoidable schedule and cost impacts. Since the assembly 100 is designed and/or size to pass through access portals and headstand, the assembly 100 can easily be removed once its inspection tasks have been completed.

Furthermore, existing inspection equipment are typically installed in the headstand utilizing a polar crane prior to the reactor vessel head being placed on the stand. The polar crane can move in a radial direction, and it is used to lift the reactor vessel head, reactor vessel missile shield, and/or pressurizer missile shield. Since the assembly 100 does not require installation assistance from the polar crane, the polar crane is freed to perform other tasks.

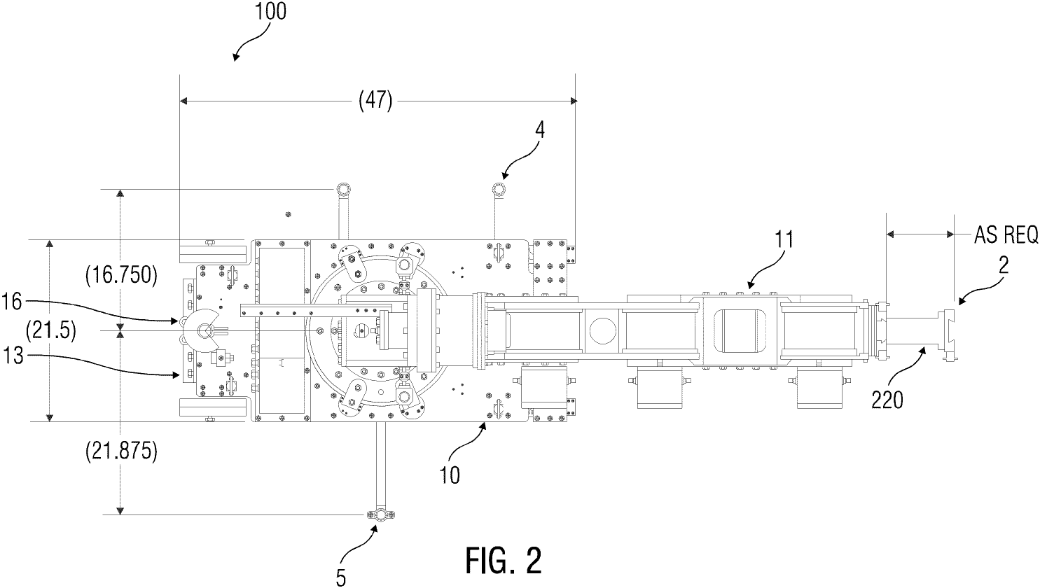

Referring primarily to FIG. 2, the mobile platform 10 of the illustrated example assembly 100 has a length of approximately 47 inches and a width of approximately 21.5 inches. However, these dimensions are not limiting. In other examples, a mobile platform 10 of an assembly 100 may have any suitable dimensions for passing through a headstand portal. The support assembly 3 is centrally, or at least substantially centrally, mounted onto the mobile platform 10. In other examples, the support assembly 3 can be mounted onto the mobile platform 10 at an off-center position to offset, or balance, the ROSA 11 when it is in a fully, or partially, extended configuration, which protects the assembly 100 from tipping over.

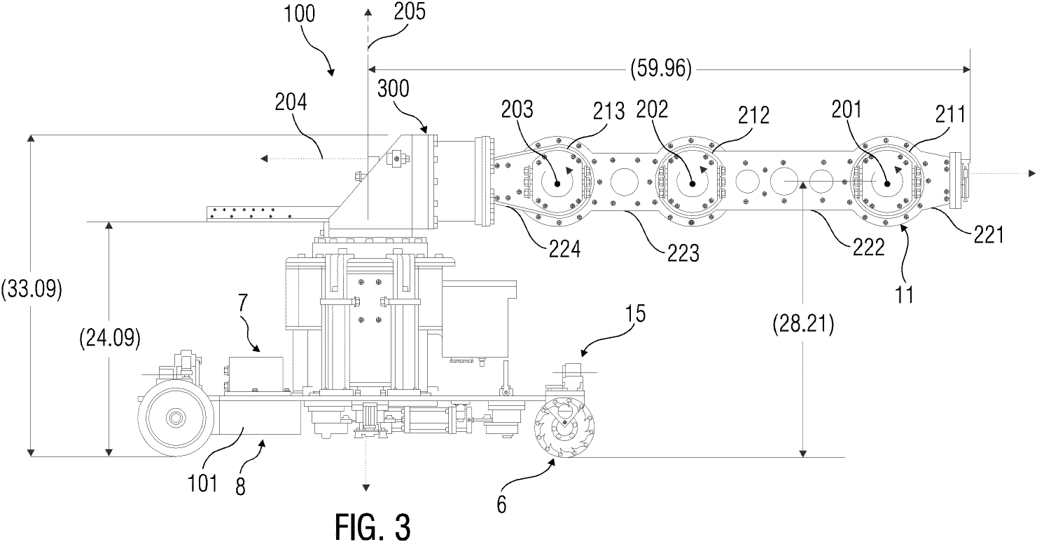

Referring to FIG. 3, the mobile platform 10 of the illustrated example assembly 100 includes an idler wheel assembly 6 and a drive wheel assembly 8 that is controlled by a motor assembly 101. The idler wheel assembly 6 comprises two wheels spaced apart laterally, and positioned at a front, or distal, portion of the mobile platform 10. Likewise, the drive wheel assembly 8 also includes two wheels spaced apart laterally, and positioned at a back, or proximal, portion of the mobile platform 10. The wheel assemblies 6, 8 cooperate to move the mobile platform 10 in response to control inputs that can, for example, be received from a remote controlling unit. In at least one example, the motor assembly 101 has the ability to drive to a specific location by typing the core location into the control software.

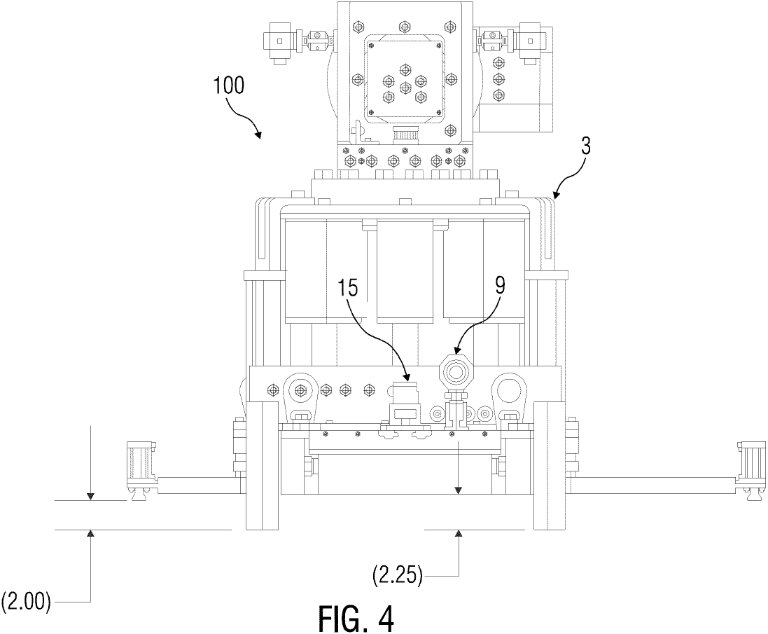

Referring to FIGS. 3 and 4, the assembly 100 can be equipped with one or more sensors for navigation and/or performing inspections such as, for example, piezoelectric sensors, electrostatic sensors, magnetorestrictive sensors, infrared sensors, and light detecting and ranging (LIDAR) sensors. In the illustrated example, a LIDAR sensor 15 is attached to the mobile platform 10 via a mount 12. The LIDAR sensor 15 is positioned at a front or distal, portion of the assembly 100, and is configured to detect peripherally located objects and/or walls. Other sensors can be similarly positioned at various locations on the assembly 100 for global positioning and/or obstacle avoidance.

LIDAR is a surveying method that measures distance to a target by illuminating the target with laser light and measuring the reflected light with a sensor. Differences in laser return times and wavelengths can then be used to make digital 3-D representations of the target.

The assembly 100 is also equipped with a camera assembly 9 for navigation and/or obstacle avoidance. In the illustrated example, the camera assembly 9 is mounted onto the front, or distal, portion of the mobile platform 10 adjacent to the LIDAR sensor 15. Live feed from the camera assembly 9 can be wirelessly transmitted to a monitor at the remote controlling unit or in a control room spaced apart from the assembly 100. The camera assembly 9 may include at least one image sensor and one or more optical components. Suitable image sensors include, but are not limited to, Charge-Coupled Device (CCD) sensors and Complementary Metal-Oxide Semiconductor (CMOS) sensors. The camera assembly 9 may include one or more illumination sources and/or one or more lenses.

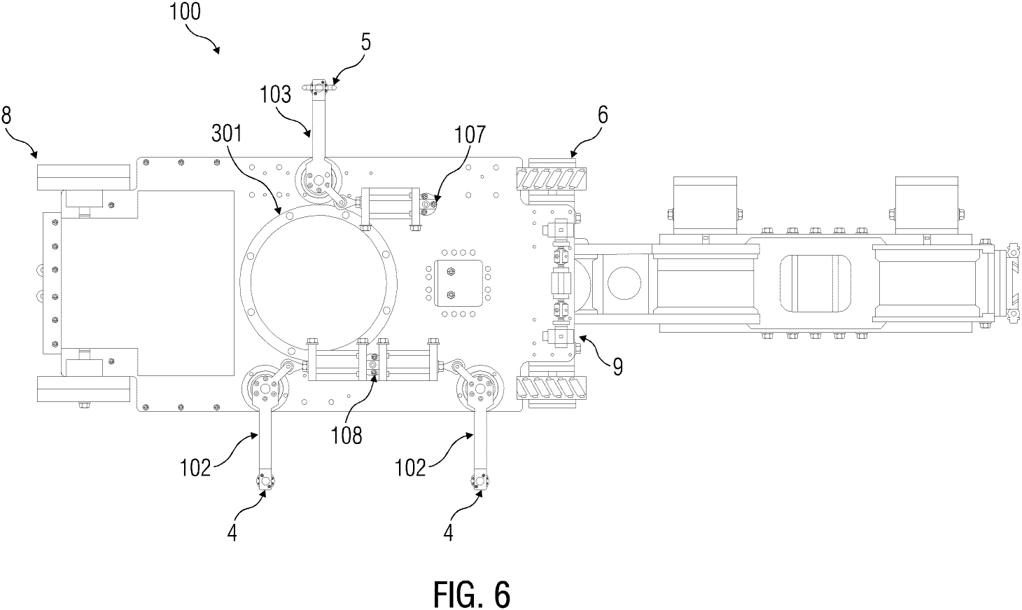

In various aspects, the assembly 100 includes one or more stabilizing members that are configured to extend outwardly from the mobile platform 10 to stabilize the assembly 100 during operation of the ROSA 11, for example. As best illustrated in FIG. 6, the assembly 100 includes two short outrigger assemblies 4 and a long outrigger assembly 5 extending from and, on opposite sides of, the mobile platform 10. In other examples, more or less than two stabilizing members can be employed to secure the assembly 100.

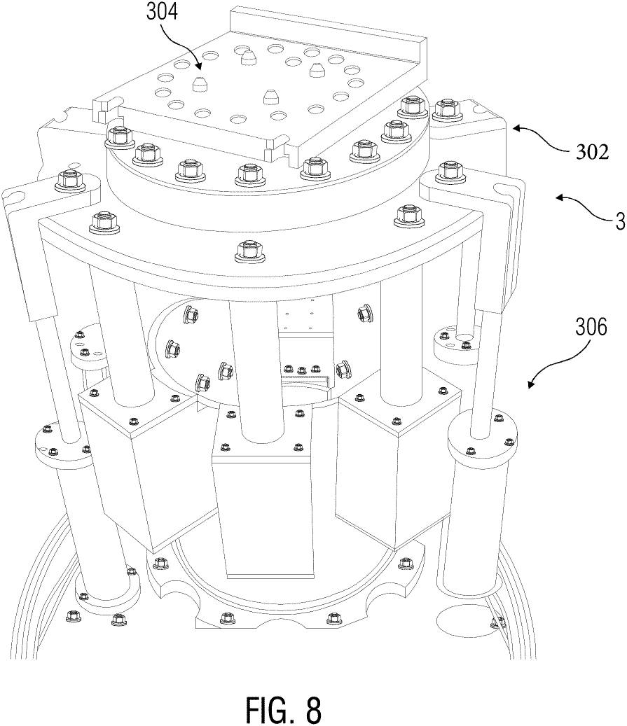

The outrigger assemblies 4, 5 include stabilizing members 102, 103 that are rotated between an un-deployed configuration (See FIG. 6), where the stabilizing members are stored under the mobile platform 10, and a deployed configuration, as illustrated in FIG. 8. Motor assemblies 107, 108 can be configured to transition the stabilizing members 102, 103, respectively, between the deployed and un-deployed configurations in response to control input from the remote controlling unit. In the illustrated example, the stabilizing members 102, 103 are rotated between the un-deployed configuration and the deployed configuration.

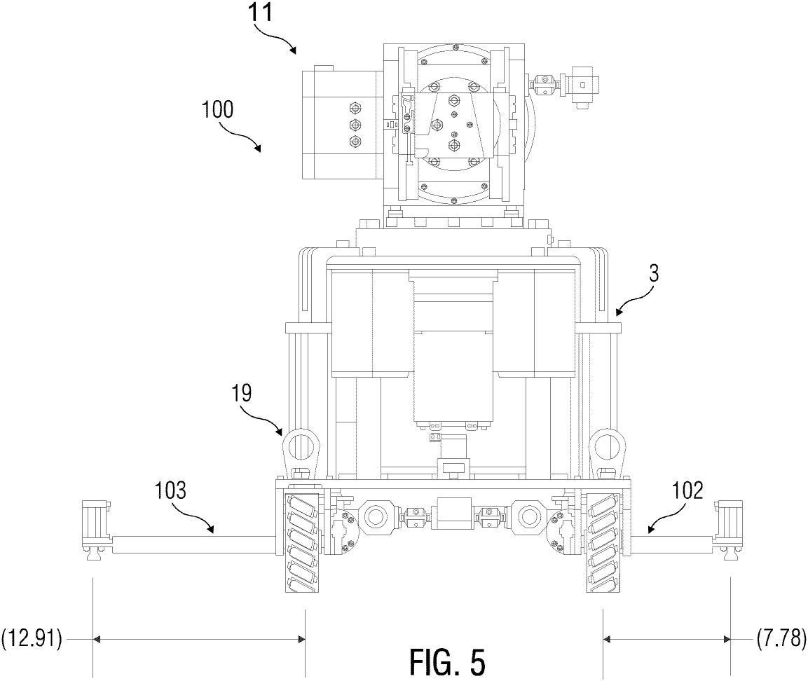

In the example illustrated in FIG. 5, the short stabilizing member 102 extends outwardly from the side of the mobile platform 10 about 7.78 inches while the long stabilizing member 103 extends outwardly from the side of the mobile platform 10 about 12.91 inches. Stabilizing members with other lengths are contemplated by the present disclosure.

Referring to FIG. 5, the assembly 100 includes hoist rings 19 that can be positioned at, or near, corners of the mobile platform 10. The hoist rings 19 can be utilized to lift and maneuver the assembly 100 into an operational location. The assembly 100 can be installed and removed while the RVH is on the headstand.

Referring primarily to FIG. 4, the height-adjustable support assembly 3 includes a plurality of concentric tubular members. The support assembly 3 further includes a motor assembly including a motor configured to on or more of the tubular members in a telescoping motion in order to change the height of the support assembly 3. Accordingly, the height of the support assembly 3 can be changed to accommodate smaller or larger headstand access portals, or higher or lower headstands. As the headstand elevation is changed, the reach requirements of the ROSA 11 can be increased or reduced by adjusting the height of the support assembly 3. The selectively changeable height allows the assembly 100 to be used to perform inspections in different sites where reach requirements can vary for each type of inspection performed, and where penetrations are on different elevations.

Referring primarily to FIG. 3, ROSA 11 includes a plurality of discrete segments 221, 222, 223, 224 extending from and/or to articulation joints 211, 212, 213. In the illustrated example, a motor assembly 231 at the articulation joint 211 causes the segment 221 to be rotated clockwise, or counter clockwise, about an articulation axis 201. Likewise, a motor assembly 232 at the articulation joint 212 causes the segment 222 to be rotated clockwise, or counter clockwise, about an articulation axis 202. Furthermore, a motor assembly 233 at the articulation joint 213 causes the segment 223 to be rotated clockwise, or counter clockwise, about an articulation axis 203. Each of the motor assemblies 231, 232, 233 at the articulation joints 211, 212, 213 includes a separate control board, and can be independently operated to position an end effector 700, connected to an extension member 220 (FIG. 2), at a desired position.

Further to the above, ROSA 11 also includes a motor assembly 234 for rotation about the longitudinal axis 204. The ROSA 11 is rotatable relative to a base portion 300 that is releasably attached to the support assembly 3. In addition, the support assembly 3 is also rotatable about the axis 205, which allows ROSA 11 to be rotated relative to the mobile frame 10.

In various examples, the one or more of the motor assemblies of the ROSA 11 may be brushless motor. In other examples, the motor may include a brushed motor, a cordless motor, a synchronous motor, a stepper motor, or any other suitable electric motor.

In various aspects, ROSA 11 can be folded into a compact configuration facilitate insertion of the assembly 100 through a headstand access port. For example, the segment 223 can be rotated clockwise about 90 degrees, and the segment 22 can be likewise rotated clockwise 90 degrees. Alternatively, in certain instances, ROSA 11 can be folded on top of the head assembly 302. In such instances, the segment 223 can be rotated counter clockwise about 90 degrees, and also the segment 222 can be rotated counter clockwise about 90 degrees. Other folding arrangements of ROSA 11 are contemplated by the present disclosure.

FIGS. 1A-1D illustrate the assembly 100 performing an inspection under a headstand. The assembly 100 was inserted through an access portal without fully lifting the headstand, which is typically performed to accommodate the introduction of existing inspection equipment, as discussed above. The assembly 100, as shown in FIGS. 1A-1D, is coupled to an end effector that is utilized to perform the inspection. The end effector position is adjusted using the support assembly 3, the ROSA 11, and/or the mobile platform 10. The mobile platform 10 permits the assembly 100 to move freely under the headstand to a desired location. Once the desired location is reached, the stabilizing members 102, 103 are deployed. Then, the support assembly 3 is employed to adjust the height of ROSA 11. Once a suitable height is reached, ROSA 11 is operated to bring the end effector 700 to a final position suitable for performing the inspection at a discrete portion of the headstand. The process is then repeated for the remaining portions.

As discussed above, different headstands have different height requirements that cannot be readily satisfied by existing inspection equipment. As such, headstands typically include dedicated unadaptable inspection equipment. On the other hand, the assembly 100 with its mobility and height adjustment capabilities is easily adaptable for insertion underneath a reactor vessel head through a standard access portal of a headstand, and for accommodating height differences among the headstands.

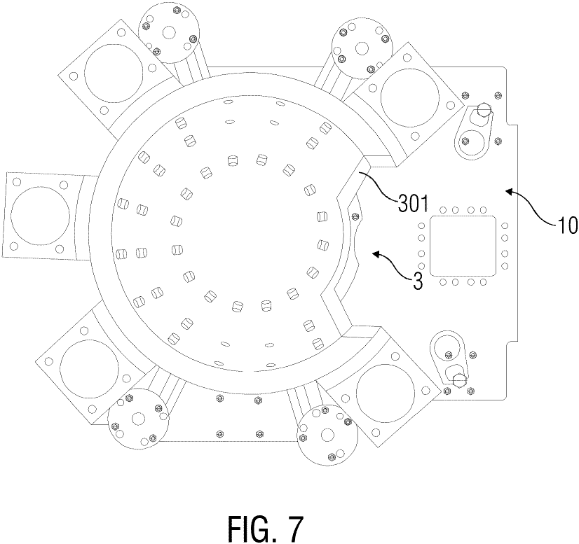

Referring primarily to FIGS. 5, 7, and 8, the support assembly 3 includes a support shell 301 fixedly attached to the mobile platform 10. A head assembly 302 is movable relative to the support shell 301. The head assembly 302 is lifted by a plurality of pneumatic cylinders to increase the height of the ROSA 11, as best shown in FIG. 8. A connector plate 304 is positioned on top of the head assembly 302. ROSA 11 is removably attached to the connector plate 304. The connector plate 304 and ROSA 11 are rotatable about the axis 205 (FIG. 3). The pneumatic cylinders 306 are configured to affect the vertical motion of the head assembly 302 relative to the support shell 301 to increase and decrease the height of ROSA 11.

In the illustrated example, the pneumatic cylinders 306 extend vertically from, and are fixedly attached to, the mobile platform 10. To ensure a stable height adjustment, the pneumatic cylinders 306 are arranged around the support shell 301.

In various aspects, as best illustrated in FIG. 2, an extension member 2 can be removably connected to the distal end of the ROSA 11. In one example, the extension member 2 defines a dovetail extension form releasably connecting to an end effector 700. Different extension members 2 with different lengths can be selected to connect the end effector 700 to ROSA 11 depending on the reach requirements.

Although the examples illustrated in FIGS. 1A-1D depict one assembly 100 performing an inspection under the reactor vessel head, it is foreseeable that two or more assemblies 100 can be deployed to simultaneously perform the inspection. Each of the deployed assemblies 100 can be assigned a section of the reactor vessel head. This approach reduces the total time required for completion of the inspection by half. Furthermore, since the assemblies 100 can be readily removed after completion of the inspection through an access port in the headstand, inspection costs are significantly reduced.

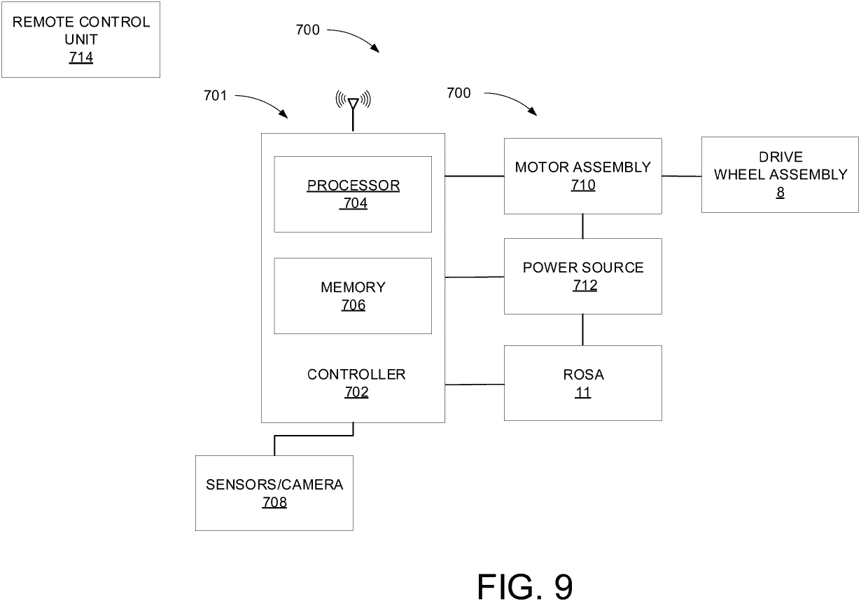

Referring to FIG. 9, a simplified schematic diagram of a control system of the RVHI platform assembly. The control system 700 includes a control circuit 701 in wireless communication with a remote control unit 714. A user may remotely transmit data, instructions, and/or operational commands to the RVHI platform assembly 100 via the remote control unit 714. The remote control unit 714 and the control circuit 700 can be connected using one or more suitable wireless communication links, for example, a radio channel, an IR channel, a RF channel, a Wireless Fidelity (WiFi) channel, and the like.

In the illustrated Example, the control circuit 701 can be configured to implement various processes described herein. The control circuit 800 may comprise a controller 702 comprising one or more processors 704 (e.g., microprocessor, microcontroller) coupled to at least one memory circuit 706. The memory circuit 706 stores machine executable instructions that when executed by the processor 704, cause the processor 704 to execute machine instructions to implement various processes described herein. The processor 704 may be any one of a number of single or multi-core processors known in the art. The memory circuit 706 may comprise volatile and non-volatile storage media. The processor 704 may include an instruction processing unit and an arithmetic unit. The instruction processing unit may be configured to receive instructions from the memory circuit 706.

The control circuit 701 can be coupled to one or more motor assemblies 710. In the illustrated example, the control circuit 701 is configured generate a motor set point signal. The motor set point signal may be provided to a motor controller of a motor assembly 710. The motor controller may comprise one or more circuits configured to provide a motor drive signal to a motor of the motor assembly 710 to drive the motor to move the dive wheel assembly 8, for example. The control circuit 701 is also coupled to a power source 712 configured to power the motor assembly 710. In the illustrated example, the power source 712 is also coupled to ROSA 11. The control circuit 701 is also configured to receive input from one or more sensors and/or cameras, as described elsewhere herein in greater detail.

In certain instances, the memory circuit 706 stores schematics of one or more reactor vessel heads including, for example, information representing geometric dimensions and characteristic features of the reactor vessel heads. The control circuit 701 may ascertain the position of the RVHI platform assembly 100 within a reactor vessel head based on sensor/camera 708 outputs and the schematics stored in the memory circuit 706. In certain instances, the control circuit 701 may cause the RVHI platform assembly 100 to automatically drive to a user defined location within a reactor vessel head. For example, the control circuit 701 may wirelessly receive a command from the remote control unit 714 for the RVHI platform assembly 100 to move to a specific location. In response, the control circuit 701 can plot a route to the specific location based on the current position of the RVHI platform assembly 100. Obstacles can be avoided by adjusting the route based on the schematics stored in the memory circuit 706, for example.

As discussed above, a proper inspection of a reactor vessel head typically involves a close inspection of its penetrations (e.g. 403, 503, 603) and surrounding welds, which requires positioning an end effector in close proximity to the penetrations/welds. In a single reactor vessel head, as illustrated in FIGS. 1A and 1B, there can be occupied penetrations (403a, 503a, 603a) and unoccupied penetrations (403b, 503b, 603b), which require different inspection heights. In various aspects, the control circuit 701 may access the schematic of a reactor vessel head and determine the relative location of each of the penetrations in the reactor vessel head. The control circuit 701 may cause the RVHI platform assembly 100 to automatically transition to the nearest penetration for inspection purposes. When the inspection is completed, the control circuit 701 may cause the RVHI platform assembly 100 to move to the next penetration, which can be triggered by a user input, for example. The relocation of the RVHI platform assembly to a particular penetration can be achieved, as discussed above, by the control circuit 701 based on the stored schematics of the reactor vessel head and the sensor/camera outputs 708.

Furthermore, the control circuit 701 may determine whether penetrations are occupied or unoccupied based on user input or the stored schematic of the reactor vessel head. Based on the result of the determination, the control circuit 701 may cause the ROSA 11 to raise the inspection end-effector to a predetermined position or distance away from the penetration, which is most suitable for performing the inspection. Detecting penetrations positions and occupation status facilitate an accurate positioning of the end effector without unintentionally bumping into the penetrations. In at least one example, the control circuit 701 may detect an occupation status of a penetration, and cause ROSA 11 to raise the inspection end effector to a predetermined height based on the occupation status of the penetration.

Furthermore, the movement and/or positioning of the RVHI platform assembly 100 can be adjusted by the user remotely through the remote control unit 714. For example, the control circuit 701 may communicate a plotted route to the user for approval prior to execution. The user may override or adjust the plotted route. In certain instances, the user may at any point of the inspection take control of the RVHI platform assembly 100 from the control circuit 701.

Various aspects of the subject matter described herein are set out in the following numbered examples.

Example 1. A mobile robotic assembly for guiding an end effector in inspecting reactor vessel heads. The mobile robotic assembly comprises a mobile platform; a support assembly extending vertically from the mobile platform, wherein the support assembly comprises an adjustable height; and a robotic arm attached to and extending laterally from the support assembly. The robotic arm comprises articulation joints; motor assemblies for driving selective articulations at each of the articulation joints; discrete segments extending between the articulation joints; a connector for releasably connecting the end effector to the robotic arm; and a rotation motor assembly for rotating the robotic arm about a longitudinal axis defined therethrough.

Example 2. The mobile robotic assembly of Example 1, wherein the support assembly comprises: a support shell; a head assembly movably supported by the support shell; and pneumatic cylinders arranged around the support shell and configured to adjust the height of the head assembly.

Example 3. The mobile robotic assembly of Example 2, wherein the mobile platform comprises stabilizing members.

Example 4. The mobile robotic assembly of Example 3, wherein the stabilizing members are rotatable between an undeployed position and a deployed position.

Example 5. The mobile robotic assembly of Example 1, 2, 3, or 4, further comprising a drive wheel assembly.

Example 6. The mobile robotic assembly of Example 1, 2, 3, 4, or 5, further comprising at least one LIDAR sensor.

Example 7. The mobile robotic assembly of Example 6, wherein the at least one LIDAR sensor is positioned at a front portion of the mobile platform.

Example 8. The mobile robotic assembly of Example 1, 2, 3, 4, 5, or 6, further comprising camera assembly.

Example 9. A method of inspecting a reactor vessel head positioned on a headstand using a mobile robotic assembly with a robotic arm positioned on an adjustable support assembly. The method comprises: passing a mobile robotic assembly through an access port of the headstand; remotely guiding the mobile robotic assembly to a first location underneath the reactor vessel head; remotely adjusting a height of the support assembly to a first height corresponding to a first inspection sight in the reactor vessel head; remotely moving the robotic arm to bring an end effector within a sufficient proximity from the first inspection sight; remotely guiding the mobile robotic assembly to a second location underneath the reactor vessel head; remotely adjusting the height of the support assembly to a second height corresponding to a second inspection sight in the reactor vessel head, wherein the second height is different than the first height; and remotely moving the robotic arm to bring the end effector within a sufficient proximity from the second inspection sight.

Example 10. The method of Example 9, wherein the first location corresponds to a first penetration of the reactor vessel head.

Example 11. The method of Example 10, wherein the second location corresponds to a second penetration of the reactor vessel head spaced apart from the first penetration.

Example 12. The method of Example 9, wherein the first height is based on an occupied penetration of the reactor vessel head.

Example 13. The method of Example 12, wherein the second height is based on an unoccupied penetration of the reactor head vessel.

Example 14. A mobile robotic assembly for guiding an end effector in inspecting a reactor vessel head. The mobile robotic assembly comprises: a mobile platform; a support assembly extending vertically from the mobile platform, wherein the support assembly comprises an adjustable height; a robotic arm attached to and extending laterally from the support assembly. The control circuit is configured to: receive a signal indicative of a specified location within a reactor vessel head; determine a current location of the mobile robotic assembly; develop a route for reaching the specified location, and cause the mobile robotic assembly to move to the specified location along the route.

Example 15. The mobile robotic assembly of Example 14, further comprising at least one sensor, wherein determining the current location is based on outputs of the at least one sensor.

Example 16. The mobile robotic assembly of Example 14 or 15, further comprising a memory circuit storing information characteristic of the reactor vessel head, wherein the route is based on the information stored in the memory circuit.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in one or more aspects of the present disclosure, a microcontroller may generally comprise a memory and a microprocessor (“processor”) operationally coupled to the memory. The processor may control a motor driver circuit generally utilized to control the position and velocity of a motor, for example. In certain instances, the processor can signal the motor driver to stop and/or disable the motor, for example. In certain instances, the microcontroller may be an LM 4F230H5QR, available from Texas Instruments, for example. In at least one example, the Texas Instruments LM4F230H5QR is an ARM Cortex-M4F Processor Core comprising on-chip memory of 256 KB single-cycle flash memory, or other non-volatile memory, up to 40 MHz, a prefetch buffer to improve performance above 40 MHz, a 32 KB single-cycle serial random access memory (SRAM), internal read-only memory (ROM) loaded with StellarisWare® software, 2 KB electrically erasable programmable read-only memory (EEPROM), one or more pulse width modulation (PWM) modules, one or more quadrature encoder inputs (QEI) analog, one or more 12-bit Analog-to-Digital Converters (ADC) with 12 analog input channels, among other features that are readily available for the product datasheet.

It should be understood that the term processor as used herein includes any suitable microprocessor, or other basic computing device that incorporates the functions of a computer’s central processing unit (CPU) on an integrated circuit or at most a few integrated circuits. The processor is a multipurpose, programmable device that accepts digital data as input, processes it according to instructions stored in its memory, and provides results as output. It is an example of sequential digital logic, as it has internal memory. Processors operate on numbers and symbols represented in the binary numeral system. In at least one instance, the processor may be any single core or multicore processor such as those known under the trade name ARM Cortex by Texas Instruments. Nevertheless, other suitable substitutes for microcontrollers and safety processor may be employed, without limitation.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

One or more drive systems or drive assemblies, as described herein, employ one or more electric motors. In various forms, the electric motors may be a DC brushed driving motor, for example. In other arrangements, the motor may include a brushless motor, a cordless motor, a synchronous motor, a stepper motor, or any other suitable electric motor. The electric motors may be powered by a power source that in one form may comprise a removable power pack. Batteries may each comprise, for example, a Lithium Ion (“LI”) or other suitable battery. The electric motors can include rotatable shafts that operably interface with gear reducer assemblies, for example. In certain instances, a voltage polarity provided by the power source can operate an electric motor in a clockwise direction wherein the voltage polarity applied to the electric motor by the battery can be reversed in order to operate the electric motor in a counter-clockwise direction. In various aspects, a microcontroller controls the electric motor through a motor driver via a pulse width modulated control signal. The motor driver can be configured to adjust the speed of the electric motor either in clockwise or counter-clockwise direction. The motor driver is also configured to switch between a plurality of operational modes which include an electronic motor braking mode, a constant speed mode, an electronic clutching mode, and a controlled current activation mode. In electronic braking mode, two terminal of the drive motor 200 are shorted and the generated back EMF counteracts the rotation of the electric motor allowing for faster stopping and greater positional precision.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

In this specification, unless otherwise indicated, terms “about” or “approximately” as used in the present disclosure, unless otherwise specified, means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A mobile robotic assembly for guiding an end effector in inspecting reactor vessel heads, the mobile robotic assembly comprising:
a mobile platform;
a support assembly extending vertically from the mobile platform, wherein the support assembly comprises an adjustable height; and
a robotic arm attached to and extending laterally from the support assembly, the robotic arm comprising:
articulation joints;
motor assemblies for driving selective articulations at each of the articulation joints;
discrete segments extending between the articulation joints;
a connector for releasably connecting the end effector to the robotic arm; and
a rotation motor assembly for rotating the robotic arm about a longitudinal axis defined therethrough.

2. The mobile robotic assembly of claim 1, wherein the support assembly comprises:
a support shell;
a head assembly movably supported by the support shell; and
pneumatic cylinders arranged around the support shell and configured to adjust the height of the head assembly.

3. The mobile robotic assembly of claim 2, wherein the mobile platform comprises stabilizing members.

4. The mobile robotic assembly of claim 3, wherein the stabilizing members are rotatable between an undeployed position and a deployed position.

5. The mobile robotic assembly of claim 1, further comprising a drive wheel assembly.

6. The mobile robotic assembly of claim 1, further comprising at least one LIDAR sensor.

7. The mobile robotic assembly of claim 6, wherein the at least one LIDAR sensor is positioned at a front portion of the mobile platform.

8. The mobile robotic assembly of claim 1, further comprising camera assembly.

9. A method of inspecting a reactor vessel head positioned on a headstand using a mobile robotic assembly with a robotic arm positioned on an adjustable support assembly, the method comprising:
passing a mobile robotic assembly through an access port of the headstand;
remotely guiding the mobile robotic assembly to a first location underneath the reactor vessel head;
remotely adjusting a height of the support assembly to a first height corresponding to a first inspection sight in the reactor vessel head;
remotely moving the robotic arm to bring an end effector within a sufficient proximity from the first inspection sight;
remotely guiding the mobile robotic assembly to a second location underneath the reactor vessel head;
remotely adjusting the height of the support assembly to a second height corresponding to a second inspection sight in the reactor vessel head, wherein the second height is different than the first height; and
remotely moving the robotic arm to bring the end effector within a sufficient proximity from the second inspection sight.

10. The method of claim 9, wherein the first location corresponds to a first penetration of the reactor vessel head.

11. The method of claim 10, wherein the second location corresponds to a second penetration of the reactor vessel head spaced apart from the first penetration.

12. The method of claim 9, wherein the first height is based on an occupied penetration of the reactor vessel head.

13. The method of claim 12, wherein the second height is based on an unoccupied penetration of the reactor head vessel.

14. A mobile robotic assembly for guiding an end effector in inspecting a reactor vessel head, the mobile robotic assembly comprising:
a mobile platform;
a support assembly extending vertically from the mobile platform, wherein the support assembly comprises an adjustable height;
a robotic arm attached to and extending laterally from the support assembly;
a control circuit configured to:
receive a signal indicative of a specified location within a reactor vessel head;
determine a current location of the mobile robotic assembly;
develop a route for reaching the specified location, and
cause the mobile robotic assembly to move to the specified location along the route.

15. The mobile robotic assembly of claim 14, further comprising at least one sensor, wherein determining the current location is based on outputs of the at least one sensor.

16. The mobile robotic assembly of claim 14, further comprising a memory circuit storing information characteristic of the reactor vessel head, wherein the route is based on the information stored in the memory circuit.
